(19) United States
(12) Patent Application Publication
(10) Pub. No.: US 2005/0140901 A1
(43) Pub. Date: Jun. 30, 2005

(54) Fringe field switching liquid crystal display

(75) Inventors: Chiu-Lien Yang, Miao-Li (TW); Jia-Pang Pang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 10/997,162

(22) Filed: Nov. 24, 2004

(30) Foreign Application Priority Data
Dec. 31, 2003 (TW) 92137539

(51) Int. Cl. G02F 1/1343; G02F 1/1335

(52) U.S. Cl. 349/141; 349/96

(57) ABSTRACT

A fringe field switching liquid crystal display (100) includes a first substrate (110) and a second substrate (120) disposed opposite each other and spaced apart a predetermined distance. A liquid crystal layer (130) is interposed between the first and second substrates. A plurality of pixel electrodes (113) is formed at the first substrate, and a counter electrode (111) is formed between the first substrate and the pixel electrodes. The pixel electrodes are parallel to each other, and the counter electrode is overlapped partially by the pixel electrodes. Two polarizers (143, 141) are attached at the first substrate and the second substrate, respectively. At least one of the two polarizers is an extraordinary type polarizer. Therefore a good contrast ratio over large viewing angles is achieved by suppressing light leakage. The positioning of a color filter (127) reduces or eliminates the adverse effects of color filter de-polarizing.

### BACKGROUND OF THE INVENTION

1. Field of the Invention

The present invention relates to a fringe field switching liquid crystal display (FFS-LCD), and especially to an FFS-LCD having good contrast ratio characteristics.

2. Description of Prior Art

The in-plane switching liquid crystal display (IPS-LCD) has been developed in order to improve on the narrow viewing angle of the standard twisted nematic liquid crystal display (TN-LCD). The IPS-LCD has a plurality of counter electrodes and a plurality of pixel electrodes all disposed on a same substrate of two opposite substrates, for driving liquid crystal molecules that are disposed between the substrates. The resulting electric field in each pixel is substantially planar, and is parallel to a surface of said same substrate. This structure provides an improved viewing angle.

However, the counter electrode and pixel electrodes are formed of opaque metals, giving the IPS-LCD a low aperture ratio and low transmittance. Thus the so-called fringe field switching liquid crystal display (FFS-LCD) has been developed in order to improve on the aperture ratio and transmittance of IPS-LCDs. The FFS-LCD is characterized by the liquid crystal molecules being driven by a fringe electric field at each pixel.

Referring to FIG. 6, this is a schematic, cross-sectional view of a conventional FFS-LCD 1, which comprises an upper substrate 20 and a lower substrate 10 disposed opposite to each other and spaced apart a predetermined distance. A liquid crystal layer 50 having a multiplicity of liquid crystal molecules (not labeled) is disposed between the upper and lower substrates 20, 10. A counter electrode 11 and a plurality of pixel electrodes 13 are disposed at the lower substrate 10, with an insulating layer 12 interposed between the counter electrode 11 and the pixel electrodes 13. A lower alignment film 14 is formed on the pixel electrodes 13 and the insulating layer 12. A color filter 25 and an upper alignment film 24 are formed on an inner surface of the upper substrate 20, in that order from top to bottom. The color filter 25 comprises a black matrix (not shown), and a color resin layer (not shown) having Red, Green and Blue segments. Two polarizers 40, 30 are attached on outer surfaces of the upper substrate 20 and the lower substrate 10, respectively. The polarizers 40, 30 are ordinary type polarizers, which are made of polyvinyl alcohol (PVA). The polarizers 40, 30 function to allow passage of ordinary polarized light beams, while blocking extraordinary polarized light beams. Polarizing axes of the polarizers 40, 30 are perpendicular to each other; that is, the polarizers 30, 40 are crossed polarizers.

When the FFS-LCD 1 is driven, a fringe electric field is formed at upper portions of the counter electrode 11 and the pixel electrodes 13 at each pixel. The liquid crystal molecules disposed over the counter electrode 11 and pixel electrodes 13 are all driven, thus giving the FFS-LCD 1 improved transmittance compared to that of an IPS-LCD.

However, light leakage occurs in an oblique viewing azimuth because of the crossed ordinary type polarizers 30, 40. As seen in FIG. 7, the leakage of light beams through the pair of crossed polarizers 40, 30 is proportional to the viewing angle. Referring to FIG. 4, the broken curve I is the contrast ratio for the polarizers 30, 40. As seen in FIG. 4, the FFS-LCD 1 has a high contrast ratio at a 0 degree viewing angle; however, the contrast ratio diminishes rapidly once the viewing angle changes from 0 degrees. The overall display quality of the FFS-LCD 1 diminishes along with the diminution in the contrast ratio.

Furthermore, the color filter 25 has a de-polarizing effect on light beams passing therethrough due to pigment light scattering. Therefore light beams passing through the FFS-LCD 1 are at least partially de-polarized by the color filter 25 before reaching the polarizer 40. This de-polarizing of the light beams prior to them reaching the polarizer 40 can reduce the contrast ratio of the FFS-LCD 1. Even though such de-polarizing effects are generally small, they can have a significant effect on the contrast ratio of the FFS-LCD 1.

It is desired to provide an FFS-LCD that can solve the above-mentioned contrast ratio and de-polarizing problems.

### SUMMARY OF THE INVENTION

An object of the present invention is to provide a fringe field switching liquid crystal display which achieves a good contrast ratio over large viewing angles.

Another object of the present invention is to provide a fringe field switching liquid crystal display which achieves a high contrast ratio by preventing any de-polarizing effects from occurring in a color filter thereof.

To achieve the above objects, a fringe field switching liquid crystal display of the present invention includes a first substrate and a second substrate disposed opposite each other and spaced apart a predetermined distance. A liquid crystal layer is interposed between the first substrate and the second substrate. A plurality of pixel electrodes is formed at the first substrate, and a counter electrode is formed between the first substrate and the pixel electrodes. The pixel electrodes are strip-shaped and parallel to each other. The counter electrode is overlapped partially by the pixel electrodes. Two polarizers are attached at the first substrate and the second substrate, respectively. A color filter is attached to an underside of the second substrate. At least one of the two polarizers is an extraordinary type polarizer. Therefore a good contrast ratio over large viewing angles is achieved by suppressing light leakage.

In certain embodiments of the present invention, the color filter is disposed above the polarizer. Therefore, a high contrast ratio is achieved by preventing any de-polarizing effects of the color filter.

Other objects, advantages, and novel features of the present invention will become more apparent from the following detailed description when taken in conjunction with the accompanying drawings, in which:

### BRIEF DESCRIPTION OF THE DRAWINGS

FIG. 1 is a schematic, side cross-sectional view of part of an FFS-LCD according to a first embodiment of the present invention;

FIG. 2 is a schematic, side cross-sectional view of part of an FFS-LCD according to a second embodiment of the present invention;

FIG. 3 is a schematic, side cross-sectional view of part of an FFS-LCD according to a third embodiment of the present invention;

FIG. 4 is a graph showing a relationship between contrast ratio and viewing angle, in respect of the FFS-LCD of the first embodiment of the present invention and in respect of the conventional FFS-LCD of FIG. 6;

FIG. 5 is a diagram showing leakage of light beams through crossed extraordinary type polarizers of the first embodiment of the present invention;

FIG. 6 is a schematic, side cross-sectional view of part of a conventional FFS-LCD; and

FIG. 7 is a diagram showing leakage of light beams through crossed ordinary type polarizers of the conventional FFS-LCD of FIG. 6.

### DETAILED DESCRIPTION OF THE INVENTION

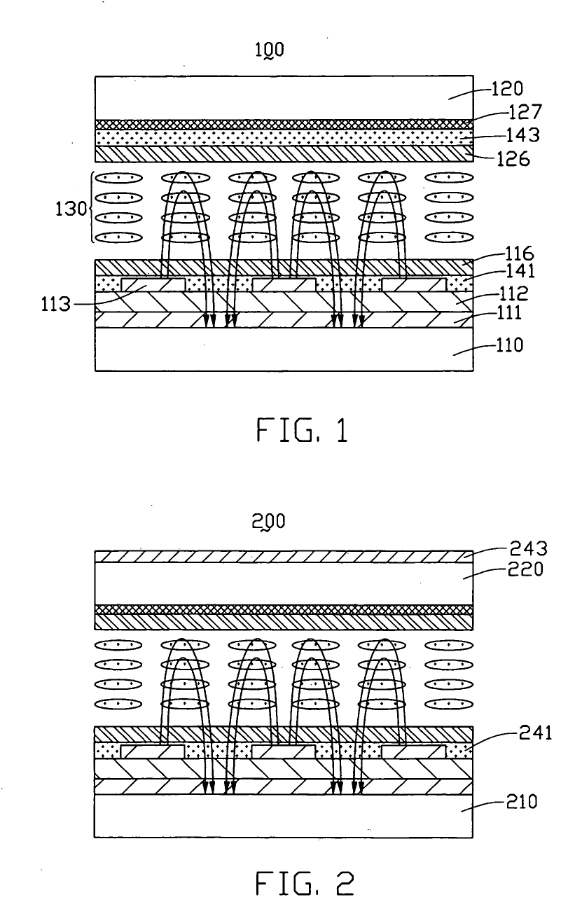

FIG. 1 is a schematic, cross-sectional view of a fringe field switching liquid crystal display (FFS-LCD) 100 according to the first embodiment of the present invention. The FFS-LCD 100 comprises a first substrate 110, a second substrate 120, and a liquid crystal layer 130 having a multiplicity of liquid crystal molecules (not labeled). The first substrate 110 and the second substrate 120 are spaced apart from each other, and the liquid crystal layer 130 is disposed therebetween. The first substrate 110 and the second substrate 120 are made of glass. Alternatively, the first substrate 110 and the second substrate 120 can be made of silicon dioxide (SiO₂).

A counter electrode 111 and a plurality of pixel electrodes 113 are disposed on the first substrate 110, with a transparent insulating layer 112 interposed between the counter and pixel electrodes 111, 113. A polarizer 141 and an alignment film 116 are formed on the pixel electrodes 113 and the insulating layer 112, in that order from bottom to top. A color filer 127, a polarizer 143 and an alignment film 126 are formed on an underside of the second substrate 120, in that order from top to bottom.

The alignment films 116, 126 are horizontal alignment layers with a low pretilt angle below 3° for orientating the liquid crystal molecules. The counter electrode 111 is plate-shaped, and each pixel electrode 113 is strip-shaped.

The color filter 127 comprises a black matrix (not shown), and a color resin layer (not shown) having Red, Green and Blue segments. The black matrix is disposed between the segments of the color resin layer to prevent light beams from leaking. The insulating layer 112 is used to prevent electrostatic buildup and eliminate afterimage. The insulating layer 112 is made of SiO₂ or silicon nitride (SiNx).

The polarizers 141, 143 are extraordinary type polarizers composed of mixtures of narrow-band components. Each component consists of a modified organic dye material which exists in a liquid-crystalline phase. Polarizing axes of the polarizers 141, 143 are perpendicular to each other; that is, the polarizers 141, 143 are crossed polarizers. The polarizers 141, 143 pass extraordinary polarized light beams, while blocking ordinary polarized light beams. A thickness of each of the polarizers 141, 143 is less than 100 micrometers. This ensures that the operating voltage of the FFS-LCD 100 will not be affected when the polarizers 141, 143 are formed at inner surfaces of the first substrate 110 and the second substrate 120, respectively.

When a voltage is applied to the counter electrode 111 and the pixel electrodes 113, a fringe electric field having horizontal components is produced therebetween at each pixel. The long axes of the liquid crystal molecules are oriented parallel to the fringe electric field. A backlight (not shown) is positioned under the first substrate 110, such that the FFS-LCD 100 operates as a transmissive mode LCD. The polarization state of light beams emitted from the backlight is changed when the light beams pass through the liquid crystal layer 130. Therefore, the light beams cannot pass through the polarizer 143 formed on the second substrate 120. As a result, the FFS-LCD 100 is in a dark state.

When no voltage is applied to the counter electrode 111 and the pixel electrodes 113, the liquid crystal molecules are oriented substantially parallel to the first substrate 110 and the second substrate 120. Long axes of the liquid crystal molecules are oriented parallel to the pixel electrodes 113. The state of polarization of light beams is not changed when the light beams pass through the liquid crystal layer 130. Therefore, the light beams can pass through the polarizer 143 formed on the second substrate 120. The light beams emitted from the polarizer 143 subsequently pass through the color filter 127 and the second substrate 120. As a result, the FFS-LCD 100 is in a bright state.

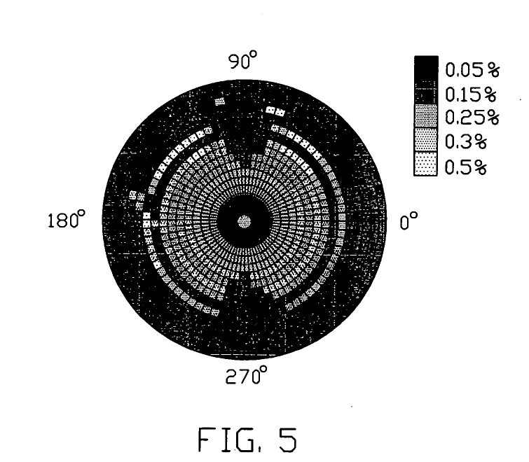

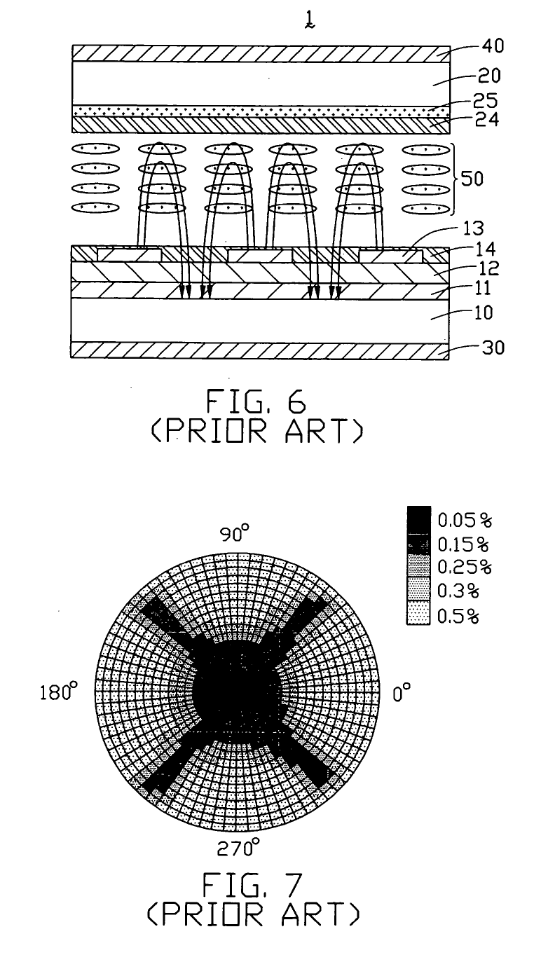

FIG. 5 shows leakage of the light beams passing through the crossed extraordinary type polarizers 141, 143. Each sector of the circle corresponds to 5 degrees of viewing angle. The center of the circle corresponds to viewing at a normal angle of incidence. As seen in FIG. 5, the leakage of light beams through the pair of crossed polarizers 141, 143 is inversely proportional to the viewing angle. That is, light leakage at large viewing angles is reduced. Referring to FIG. 4, the continuous curve II is the contrast ratio for the polarizers 141, 143. It illustrates that the polarizers 141, 143 have a good contrast ratio over large viewing angles. As a result, the display quality of the FFS-LCD 100 is improved.

Furthermore, the color filter 127 is disposed under the second substrate 120 above the polarizer 143. This arrangement reduces or eliminates the adverse effects of color filter de-polarizing, and yields a higher contrast ratio.

Referring to FIG. 2, this is a schematic, cross-sectional view of an FFS-LCD 200 according to the second embodiment of the present invention. The FFS-LCD 200 is similar to the FFS-LCD 100 of the first embodiment, and comprises a first substrate 210 and a second substrate 220. An extraordinary type polarizer 241 is formed at an inner surface of the first substrate 210, and an ordinary type polarizer 243 is formed on an outer surface of the second substrate 220. The polarizer 243 and the polarizer 241 are crossed polarizers. Referring to FIG. 5 and FIG. 7 again, FIG. 5 shows leakage of light beams passing through extraordinary type polarizers, and FIG. 7 shows leakage of light beams passing through ordinary type polarizers. A corresponding diagram for the FFS-LCD 200 would essentially be a combination of the leakage of light beams shown in FIGS. 5 and 7. As seen in FIGS. 5 and 7, the respective leakages of light beams are substantially complementary to each other. That is, dark regions of FIG. 5 correspond to light regions of FIG. 7, and vice versa. The combination of the ordinary type polarizer 243 and the extraordinary type polarizer 241 can provide complete extinction of light beams at all viewing angles.

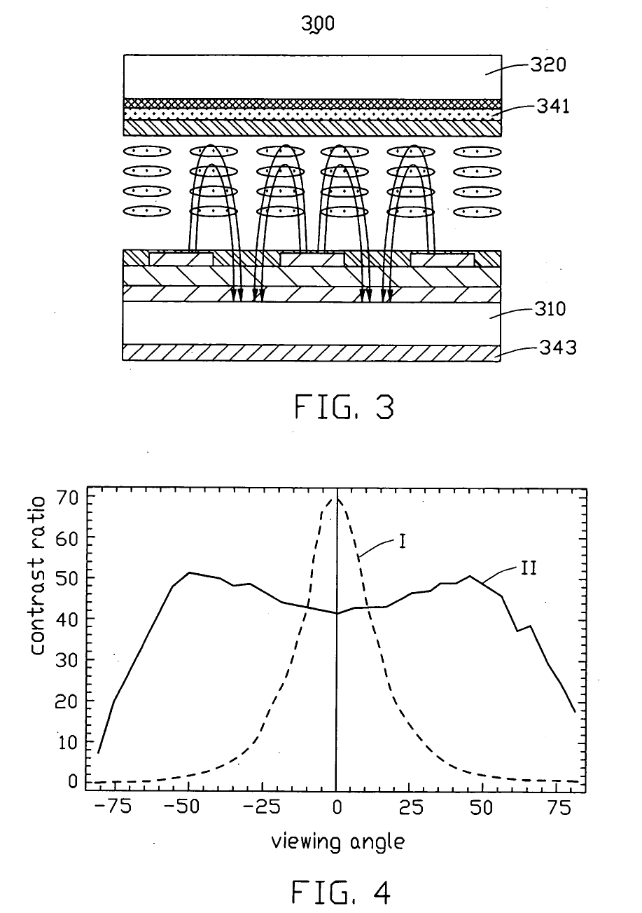

Referring to FIG. 3, this shows a schematic, cross-sectional view of an FFS-LCD 300 according to the third embodiment of the present invention. The FFS-LCD 300 is similar to the FFS-LCD 200, and comprises a first substrate 310 and a second substrate 320. An extraordinary type polarizer 341 is formed at an undersurface of the second substrate 320, and an ordinary type polarizer 343 is formed on an undersurface of the first substrate 310. Polarizing axes of the polarizers 343, 341 are perpendicular to each other.

A color filter (not labeled) is disposed under the second substrate 320 above the polarizer 341. This arrangement reduces or eliminates the adverse effects of color filter de-polarizing, and yields a higher contrast ratio.

In the present invention, the FFS-LCDs 100, 200 and 300 are transmissive mode LCDs. In alternative embodiments, the FFS-LCDs 100, 200, and 300 can each be configured as a transflective mode LCD or a reflective mode LCD.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

1. A fringe field switching liquid crystal display, comprising:
a first substrate and a second substrate disposed opposite each other and spaced apart a predetermined distance;
a liquid crystal layer interposed between the first substrate and the second substrate;
a plurality of pixel electrodes formed on the first substrate, the pixel electrodes being parallel to each other;
a counter electrode formed between the first substrate and the pixel electrodes, the counter electrode being overlapped partially by the pixel electrodes; and
an upper polarizer and a lower polarizer attached at the second substrate and the first substrate, respectively;
wherein at least one of the two polarizers is an extraordinary type polarizer.

2. The fringe field switching liquid crystal display as claimed in claim 1, wherein the upper polarizer is formed at an inner surface of the second substrate.

3. The fringe field switching liquid crystal display as claimed in claim 2, further comprising a color filter disposed between the second substrate and the upper polarizer.

4. The fringe field switching liquid crystal display as claimed in claim 3, wherein the upper polarizer is an extraordinary type polarizer.

5. The fringe field switching liquid crystal display as claimed in claim 4, wherein the lower polarizer is an extraordinary type polarizer.

6. The fringe field switching liquid crystal display as claimed in claim 5, wherein the lower polarizer is formed at an inner surface of the first substrate.

7. The fringe field switching liquid crystal display as claimed in claim 4, wherein the lower polarizer is an ordinary type polarizer.

8. The fringe field switching liquid crystal display as claimed in claim 7, wherein the lower polarizer is formed on an outer surface of the first substrate.

9. The fringe field switching liquid crystal display as claimed in claim 1, wherein the upper polarizer is formed on an outer surface of the second substrate.

10. The fringe field switching liquid crystal display as claimed in claim 9, wherein the upper polarizer is an ordinary type polarizer.

11. The fringe field switching liquid crystal display as claimed in claim 10, wherein the lower polarizer is formed at an inner surface of the first substrate.

12. The fringe field switching liquid crystal display as claimed in claim 11, wherein the lower polarizer is an extraordinary type polarizer.

13. The fringe field switching liquid crystal display as claimed in claim 1, wherein polarizing axes of the upper polarizer and the lower polarizer are perpendicular to each other.

14. The fringe field switching liquid crystal display as claimed in claim 13, wherein the extraordinary type polarizer is made of a modified organic dye material which exists in a liquid crystalline phase.

15. The fringe field switching liquid crystal display as claimed in claim 1, wherein the fringe field switching liquid crystal display is a transmissive mode liquid crystal display.

16. The fringe field switching liquid crystal display as claimed in claim 1, wherein the fringe field switching liquid crystal display is a transflective mode liquid crystal display or a reflective mode liquid crystal display.

17. A fringe field switching liquid crystal display, comprising:
a first substrate and a second substrate disposed opposite each other and spaced apart a predetermined distance;
a liquid crystal layer interposed between the first substrate and the second substrate;
a counter electrode disposed on the first substrate;
a plurality of pixel electrodes disposed at the first substrate; and
an upper polarizer and a lower polarizer attached at the second substrate and the first substrate, respectively;
wherein fringe electric fields having horizontal components are generated between the pixel electrodes and the counter electrode when a voltage is applied therebetween; and
at least one of the two polarizers is an extraordinary type polarizer.

18. A fringe field switching liquid crystal display, comprising:
a first substrate and a second substrate disposed opposite each other and spaced apart a predetermined distance;
a liquid crystal layer interposed between the first substrate and the second substrate;
a plurality of pixel electrodes formed at the first substrate, the pixel electrodes being parallel to each other;
a counter electrode formed between the first substrate and the pixel electrodes, the counter electrode being overlapped partially by the pixel electrodes; and
an extraordinary type polarizer formed at an inner surface of the second substrate.

19. The fringe field switching liquid crystal display as claimed in claim 18, wherein the polarizer is made of a modified organic dye material which exists in a liquid-crystalline phase.

20. The fringed field switching liquid crystal display as claimed in claim 19, further comprising a color filter disposed between the second substrate and the polarizer.
